(19) United States
(12) Patent Application Publication
(10) Pub. No.: US 2011/0291426 A1
(43) Pub. Date: Dec. 1, 2011

(54) BURGLAR BLOCK SYSTEMS

(76) Inventor: Gideon Gibson, Yonkers, NY (US)

(21) Appl. No.: 13/112,539

(22) Filed: May 20, 2011

Related U.S. Application Data
(60) Provisional application No. 61/349,420, filed on May 28, 2010.

(51) Int. Cl. E05B 65/00; E05C 1/02

(52) U.S. Cl. 292/137

(57) ABSTRACT

The home invasion deterrent system comprising a flush-mounted floor bracket with an aperture for inserting a vertical column assembly. The floor bracket may be mounted over and aligned with a core drilled hole in a (concrete) floor. The vertical column assembly has affixed at the upper end a door stopping plate support arm with a door stopping plate and rubber bumper block mounted to it parallel to an entry door. The door stopping plate is adjustable in proximity to the entry door to a user-preferred distance and secured in position with a locking pin (or threaded means) to allow the user to ascertain a visitor's identity safely without the visitor gaining entry without permission. Other embodiments, kits and method(s) of use are also embodied.

### CROSS-REFERENCE TO RELATED APPLICATION

The present application is related to and claims priority from prior provisional application Ser. No. 61/349,420, filed May 28, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of home security devices and more specifically relates to door blocking systems.

### DESCRIPTION OF THE RELATED ART

Crime has always been a problem in population centers throughout history and our modern societies are no exception. Over-crowding and economic pressures tend to exasperate crime statistics. Robberies and home invasion statistics are on the rise with many of the victims of home invasions losing their lives. Criminals and gangs have discovered that home invasion and burglary is often lucrative with little resistance and that homeowners are typically left to take the best preventative measures they believe will protect their families and their property. As a result homeowners are often ill-prepared to properly deal with such situations. Physical security measures may be used as a first line of defense against such types of crime.

Physical security can be as simple as locks on doors or as elaborate as multiple layers of barriers, armed security guards and guardhouse placement. Good physical security uses the concept of layered defense, in appropriate combinations to deter and delay intrusions (passive defense), and detect and respond to intrusions (active defense). Ideally the deterrence should be viewed by a potential intruder as too difficult, risky or costly for the intruder to even attempt an intrusion. However, strong security measures also come at a cost, and there can be no perfect security. A security designer may be employed to balance security features and a tolerable amount of personnel access against available resources, risks to assets to be protected and even aesthetics; however this may be an expensive process.

There are also life-cycle sustaining costs to consider. Physical security is not a modern phenomenon. Physical security exists in order to deter persons from entering a physical facility. Passive infrared (PIR) based technology, electronic access control systems, and video surveillance system (VSS) cameras, are also expensive and not a financially practical solution for most homeowners. As a result door locks and deadlocks are the most common physical security measures but offer little security when the homeowner opens the door from the inside to answer a knock at the door. Home invasions often begin when an intruder kicks the door in at the first sign that the homeowner has unlatched the door. Security chains are typically too flimsy to defend against such force. A durable effective solution is needed.

Various attempts have been made to solve the above-mentioned problems such as those found in U.S. Pat. Nos. 4,671,014; 5,340,172; 3,980,328; 4,858,972; 4,676,536; and 2,421,275. This prior art is representative of door blocking systems. None of the above inventions and patents, taken either singly or in combination, is seen to describe the invention as claimed.

Ideally, a home security device should be secure, durable and convenient to use, and yet, would operate reliably and be manufactured at a modest expense. Thus, a need exists for a reliable door security system to provide greater home security and to avoid the above-mentioned problems.

### BRIEF SUMMARY OF THE INVENTION

In view of the foregoing disadvantages inherent in the known door security art, the present invention provides a novel home invasion deterrent system. The general purpose of the present invention, which will be described subsequently in greater detail, is to provide increased and effective home security.

The home invasion deterrent system as disclosed herein comprises various embodiments, a preferred embodiment preferably comprising: a floor (floor mountable) bracket with an aperture for inserting a column, the floor bracket being rigidly affixed to a floor in a flush-mounted condition. Within this particular embodiment the floor bracket receives the vertical column assembly, the vertical column assembly having an upper end and a lower end. The vertical column assembly preferably has affixed at the upper end a door stopping plate support arm which is at a right angle (preferably perpendicular however other angles may be suitable) to the upper end of the vertical column assembly. The door stopping plate support arm preferably has a door stopping plate rigidly and perpendicularly attached and the unit is slideably insertable into the door stopping plate support arm receiver which has a plurality of orifices. The receiver may be affixed at a ninety degree angle to the upper end of the vertical column. The orifices comprise through holes wherein one of the plurality of orifices may be aligned with one of the through holes and a rod or a locking pin entered through the orifice and the through hole at the user-preferred distance between the door stopping plate and an entry door, such that the system is user-adjustable.

Certain alternate embodiments also discussed herein may have the door stopping plate affixed to all-thread wherein the door stopping plate support is threadably insertable into the upper end of the vertical column assembly. The inserted vertical column assembly, with the door stopping plate inserted may be adjusted to the user preferred spacing enabling an occupant to open an entry door a predetermined rotatable distance to ascertain a visitor's identity safely without providing such an opening that the visitor may gain entry without permission.

The home invasion deterrent system may comprise exactly one vertical column assembly for use with a single entry door or, in some embodiments, the home invasion deterrent system may comprise a plurality of vertical column assemblies for use with a double entry door wherein the plurality of vertical column assemblies may be affixed to one cross-beam that limits the opening distance of one or preferably both doors. The cross-beam version may comprise at least two locking pins and the cross-beam may be mounted between the vertical column assembly and a double entry door. This embodiment may further comprise a handle for lifting and removing the cross-beam when entry is desired by the user (occupant—for ease of handling.)

The door stopping plate support arm which preferably has the door stopping plate rigidly affixed, comprises a rubber bumper attached to the planar surface of the door stopping plate (which faces the door) to prevent unintended damage to the door and acts as a door stop. The vertical column assembly when slideably inserted into the floor bracket creates a door swing limiter whereby a potential home invader is substantially prevented from ingressing an entryway. The vertical column assembly is rigidly inserted through the floor bracket(s) and into a core hole(s) in a concrete floor. In a double entry door, two vertical column assemblies may be rigidly inserted through two floor brackets and into two (separate) core holes in a concrete floor. These embodiments may be used to prevent one or two doors from being pushed open by an intruder against the wishes of the occupant.

Alternate embodiments may comprise a horizontal column assembly hingedly attached to an adjacent planar surface (to the entry door). This particular embodiment may comprise a locking pin hole on the bar between the hinged end and the opposing end which contains the door stopping plate support arm with the door stopping plate. The horizontal column assembly is hingedly rotatable toward the entry door into a user-desired position (locking position), the locking pin hole in the horizontal column assembly aligns with the through holes in the bracket mounted to the planar surface and is locked into position with a locking pin. With a locking pin inserted through the horizontal column assembly and the bracket, the door when opened is limited as to its relative rotation. The device may be swung away at the user's discretion to allow ingress/egress. In other embodiments, a wall bracket may be used instead of a floor bracket and the column assembly may be horizontally positioned instead of vertically positioned.

A method of use of a home invasion deterrent system is also disclosed herein comprising the steps of: inserting a vertical column assembly having an upper end and a lower end into a floor bracket and core hole; adjusting a door stopping plate support arm with a rubber bumper to a desired position; and inserting a locking pin through said door stopping plate support arm to secure an entryway door. The method of use of a home invasion deterrent system may further comprise the steps of: removing the door stopping plate support arm with said rubber bumper; and opening the door thereby providing an egress and ingress pathway for a user. Various methods and steps may be used with the various embodiments described herein.

Burglar Block Systems may be sold as kit comprising the following parts: at least one floor bracket; at least one vertical column assembly(s); at least one door stopping plate support arm; at least one door stopping plate; and at least one set of user instructions. Burglar Block Systems may be manufactured and provided for sale in a wide variety of sizes and shapes for a wide assortment of applications.

The present invention holds significant improvements and serves as a home invasion deterrent system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Burglar Block Systems, constructed and operative according to the teachings of the present invention.

FIGS. 1A and 1B show perspective views illustrating Burglar Block Systems as used with a single entry door in an in use condition according to an embodiment of the present invention.

FIGS. 2A-2B show perspective views illustrating the Burglar Block Systems as used with a double entry door in an in use condition according to an embodiment of the present invention of FIG. 1A.

FIGS. 3A and 3B are perspective views illustrating another embodiment of the Burglar Block System(s) using wall brackets instead of a floor bracket according to an embodiment of the present invention of FIG. 1A.

FIG. 4 is a perspective view illustrating another embodiment of the Burglar Block Systems according to an embodiment of the present invention of FIG. 1B.

FIG. 5 is a flowchart illustrating a method of using Burglar Block Systems according to an embodiment of the present invention of FIGS. 1A-4.

The various embodiments of the present invention will hereinafter be described in conjunction with the appended drawings, wherein like designations denote like elements.

### DETAILED DESCRIPTION

As discussed above, embodiments of the present invention relate to a home security device, and more particularly to a door blocking system as used to improve security for residential and commercial occupants.

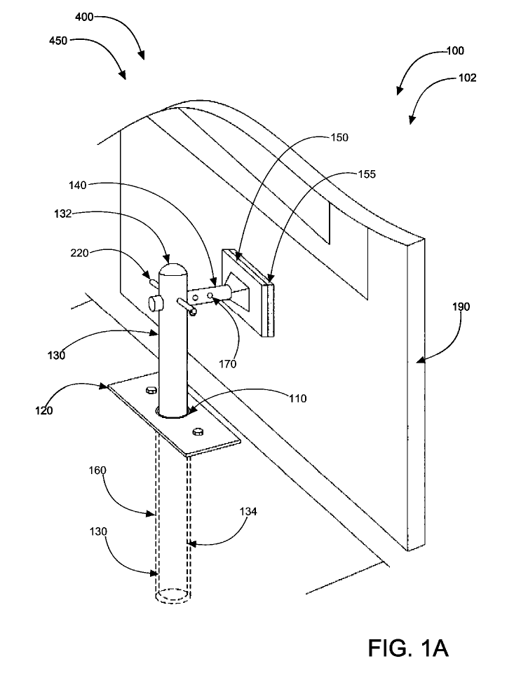

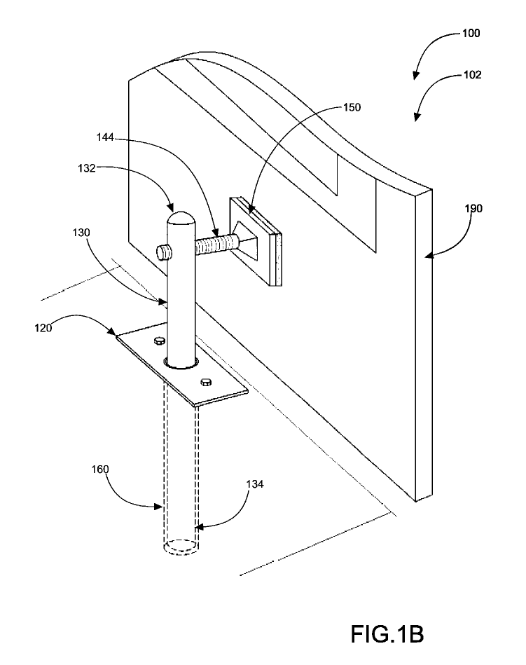

Referring now to the drawings by numerals of reference there is shown in FIGS. 1A and 1B, perspective views illustrating Burglar Block Systems 100 for use with single entry door 110 constructions in an in-use condition 450 according to an embodiment of the present invention. Home invasion deterrent system 102 within this particular embodiment may comprise at least one (preferably one) floor bracket 120, at least one (preferably one) vertical column assembly 130 having an upper end 132 and a lower end 134, at least one (preferably one) door stopping plate support arm 140, and at least one (preferably one) door stopping plate 150.

Floor bracket 120 may be floor mountable and is designed to receive vertical column assembly 130. Door stopping plate support arm 140 and door stopping plate 150, when assembled and inserted, act in the capacity of a door stop. Vertical column assembly 130 when slideably inserted into floor bracket 120, creates a door swing limiter whereby a potential home invader is prevented from ingressing an entryway. This is accomplished by allowing the door to only open a pre-determined distance such that an occupant can view the individual seeking entry, but not such a distance whereby an intruder may kick in the door to gain entry. In this way the present invention provides safety for its users.

Floor bracket 120 preferably comprises an aperture and may be rigidly affixed (into) to a floor in a flush-mounted condition over core hole 160 (core hole 160 preferably in a concrete floor) for rigidity of an inserted vertical column assembly 130. The aperture in floor bracket 120 and core hole 160 are aligned such that vertical column assembly 130 can be inserted and removed with frictional-ease. Vertical column assembly 130 of home invasion deterrent system 102 preferably comprises door stopping plate support arm 140 affixed at a right angle (in this particular embodiment, but may be at various angles in other variations) to upper end of vertical column assembly 130. Vertical column assembly 130 is designed to prevent door from rotating to a completely open condition, unless occupant removes or otherwise moves vertical column assembly 130 as an obstacle from path of the door.

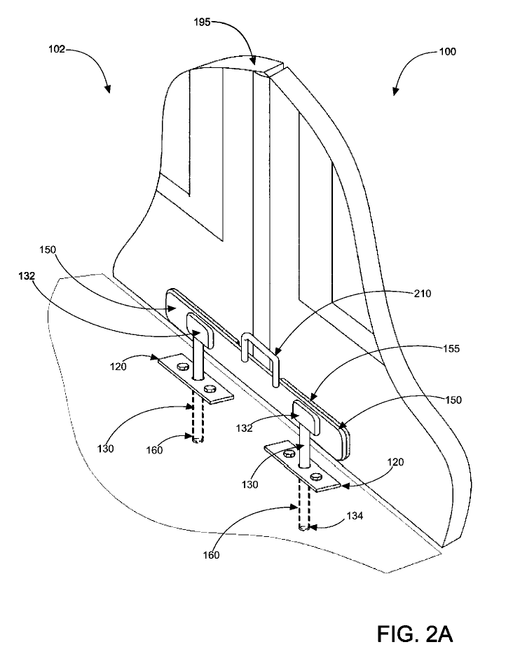

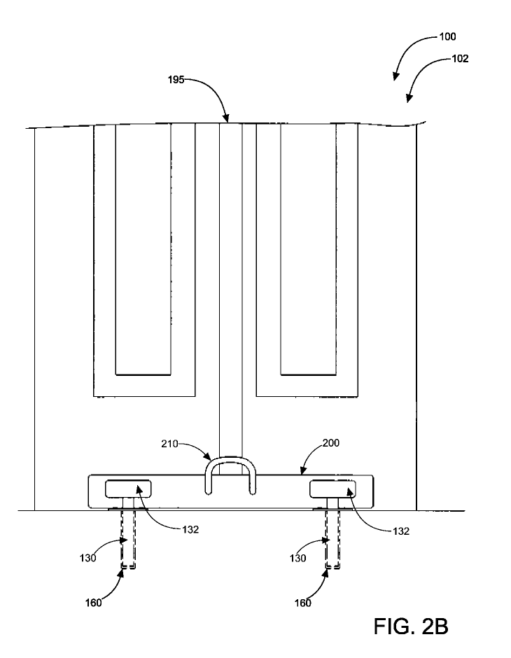

Door stopping plate support arm 140 may comprise a plurality of orifices 170 and door stopping plate 150 may comprise a plurality of through holes in the embodiment shown in FIG. 1A. In this particular version one of the plurality of orifices 170 may be aligned with one of the plurality of through holes 180 and rod 175 entered through one of a plurality of orifices 170 and through holes 180 to create a fixed-relationship. In this way a user-preferred distance may be pre-set between door stopping plate 150 and entry door 190, this distance may be set to where an occupant can readily see the potential entrant or less of a distance if preferred. The home invasion deterrent system 102 door stopping plate support arm 140 may comprise all-thread 144 (shown in FIG. 2B) instead of rod 175 or a tube with a plurality of orifices 170. In this version the distance may be set via threadingly adjusting door stopping plate 150 inwardly or outwardly from the door.

Door stopping plate 150 may comprise rubber bumper 155 or a combination of layered materials constructed such that it has a shock absorbing ability. Home invasion deterrent system 102 comprises exactly one vertical column assembly 130 in embodiments for use with single entry door 190 (in most circumstances) and may be rigidly insert into one core hole 160 in a concrete floor. When vertical column assembly 130 is inserted and door stopping plate 150 is adjusted in distance to single entry door 190, an occupant is able to safely open single entry door 190 a predetermined rotatable distance to ascertain a visitor's identity.

Referring now to FIGS. 2A and 2B showing perspective views illustrating Burglar Block Systems 100 for use with double entry door(s) 195 in an in-use condition 450 according to an embodiment of the present invention of FIG. 1A.

This specific embodiment of home invasion deterrent system 102 preferably comprises a plurality of vertical column assembly(s) 130 for use with double entry door 195, as shown. Two vertical column assembly(s) 130 are preferably rigidly inserted into two floor brackets 120 and also into two core holes 160 in a concrete floor (or other.) One (or more) cross-beam 200 may be mounted to two vertical column assembly(s) 130 to create a larger surface area in which to absorb inward pressure from the door(s). Cross-beam 200 is preferably mounted between vertical column assembly(s) 130 and double entry door 195 to absorb force and distribute the energy of impact if imparted thereupon. Cross-beam 200 further comprises handle 210 for easily lifting of cross-beam 200 and vertical column assembly(s) 130 to insert into floor brackets 120. Cross-beam 200 may comprise at least two locking pin(s) 220 for securing a user desired distance from double entry door 195.

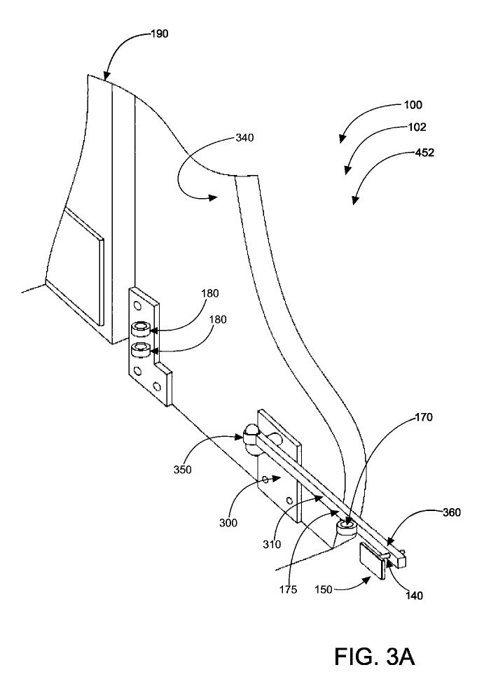

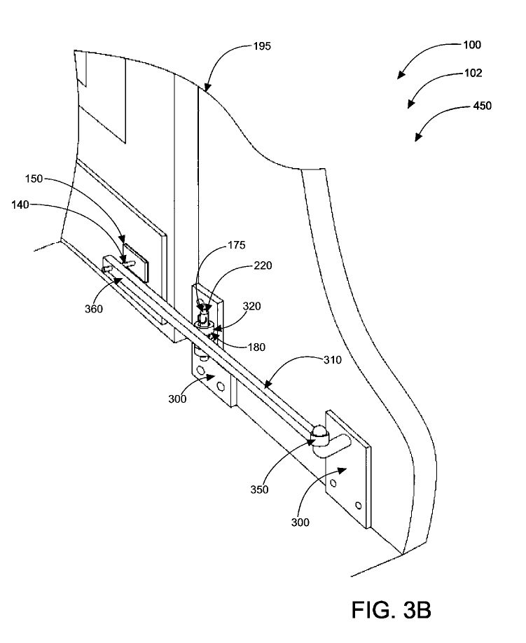

Referring now to FIGS. 3A and 3B showing perspective views illustrating an alternate embodiment of Burglar Block Systems 100 using wall brackets 300 instead of floor bracket(s) 120 according to an embodiment of the present invention of FIG. 1A.

Certain embodiments may comprise horizontal column assembly 310 hingedly attached on proximate end 350 to adjacent planar surface 340 of single entry door 190. These embodiments may comprise orifice(s) 170 on horizontal column assembly 310 between proximate end 350 and distal end 360. Distal end 360 comprises door stopping plate support arm 140 with door stopping plate 150 which may be swung into and away from contact with the ‘protected’ door to allow or limit opening. This particular embodiment is handy in that horizontal column assembly 310 may be easily and conveniently moved out of the way for ingress of welcomed individuals.

Wall bracket(s) 300 containing through holes 180 is preferably rigidly mounted to an adjacent planar surface 340 such that when horizontal column assembly 310 is hingedly rotated toward single entry door 190 into a user desired position, orifice(s) 170 affixed to horizontal column assembly 310 aligns with through holes 180 in wall bracket(s) 300 mounted to the adjacent planar surface 340 and is locked into position with locking pin(s) 220. With locking pin(s) 220 inserted through horizontal column assembly 310 and wall bracket(s) 300, the single entry door 190 when opened is rotatably limited. Horizontal column assembly 310 is hingedly rotated away from single entry door 190 against adjacent planar surface 340 to comprise a non-use condition 452.

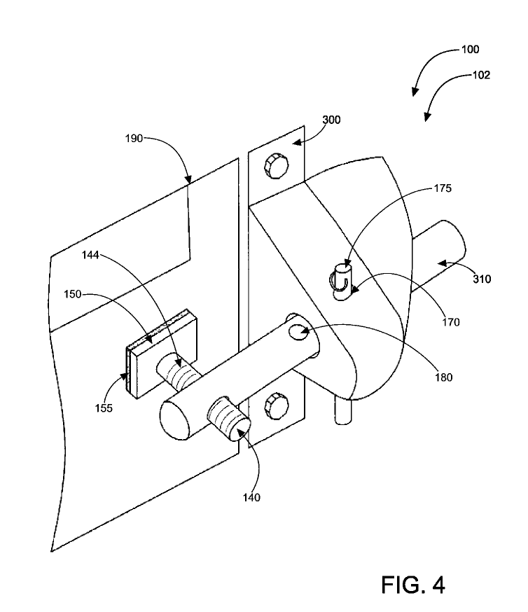

Referring now to FIG. 4 showing perspective views illustrating yet another embodiment of Burglar Block Systems 100 according to an embodiment of the present invention of FIG. 1B.

In these embodiments, wall bracket(s) 300 may be used instead of (or in addition to) floor bracket 120 and vertical column assembly(s) 130 may be horizontally oriented instead of vertically oriented. Horizontal column assembly 330 may comprise a plurality of through holes 180 or in some embodiments may comprise all-thread 144 (both options alluded to) as door stopping plate support arm 140 is removably affixed to door stopping plate 150 such that it may be rotatably adjusted to a user-defined position and locked into position by inserting locking pin(s) 220. The various embodiments of the present invention may be located on right or left sides of the door, on the top or bottom, as per the desired application.

Burglar Block Systems 100. Burglar Block Systems 100 may be sold as kit(s) 400 comprising the following parts: at least one floor bracket 120; at least one vertical column assembly(s) 130; at least one door stopping plate support arm 140; at least one door stopping plate 150; and at least one set of user instructions. Kits 400 may be sold for the various embodiments discussed herein and various combinations thereof. Burglar Block Systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different designs and profiles for different doors and combinations of doors, parts may be sold separately, etc., may be sufficient.

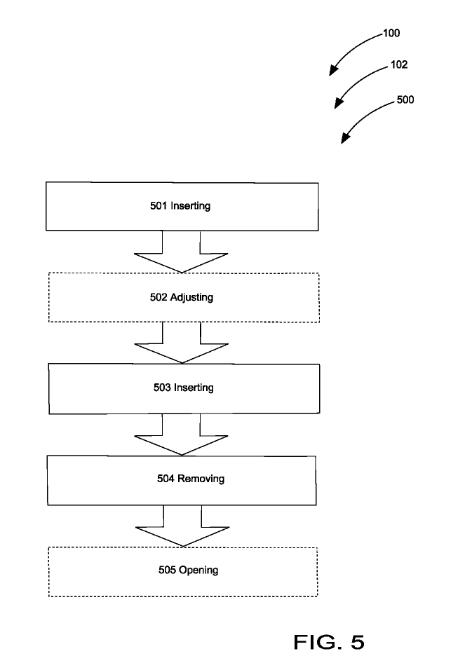

Referring now to FIG. 5, a flowchart illustrating a method of use 500 for Burglar Block Systems 100 according to an embodiment of the present invention of FIGS. 1A-4. A method of use 500 of home invasion deterrent system 102 preferably comprising the steps of: inserting vertical column assembly(s) 130 having an upper end and a lower end into floor bracket 120 and core hole 160; (optionally) adjusting door stopping plate 150 support arm with rubber bumper 155 to a desired position; and inserting locking pin(s) 220 through door stopping plate support arm 140 to secure single entry door 190. The method of use 500 of home invasion deterrent system 102 may further comprise the steps of: removing door stopping plate support arm 140; and opening single entry door 190 or double entry door 195 thereby providing an egress and ingress pathway for a user.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. The home invasion deterrent system comprising:
a floor bracket;
a vertical column assembly having an upper end and a lower end,
a door stopping plate support arm; and
a door stopping plate;
wherein said floor bracket is floor mountable and receives said vertical column assembly;
wherein said door stopping plate support arm and said door stopping plate act as a door stop; and
wherein said vertical column assembly when slideably inserted into said floor bracket creates a door swing limiter whereby a potential home invader is prevented from ingressing an entryway.

2. The home invasion deterrent system of claim 1 wherein said floor bracket comprises an aperture, said floor bracket is rigidly affixed to a floor in a flush-mounted condition.

3. The home invasion deterrent system of claim 1 wherein said vertical column comprises said door stopping plate support arm affixed at a right angle to said upper end of said vertical column assembly.

4. The home invasion deterrent system of claim 1 wherein said door stopping plate comprises a rubber bumper.

5. The home invasion deterrent system of claim 1 wherein said vertical column assembly is rigidly friction-inserted into a core hole in a concrete floor.

6. The home invasion deterrent system of claim 1 wherein said home invasion deterrent system comprises exactly one vertical column assembly providing said home invasion deterrent system for use with a single entry door.

7. The home invasion deterrent system of claim 1 wherein said home invasion deterrent system comprises a plurality of vertical column assemblies providing said home invasion deterrent system for use with a double entry door.

8. The home invasion deterrent system of claim 7 wherein said vertical column assemblies are rigidly inserted into two core holes in a concrete floor.

9. The home invasion deterrent system of claim 7 further comprising a cross-beam.

10. The home invasion deterrent system of claim 9 wherein said cross-beam further comprises a handle.

11. The home invasion deterrent system of claim 1 wherein said vertical column assembly enables an occupant to open an entry door a predetermined rotatable distance to ascertain a visitor's identity.

12. The home invasion deterrent system of claim 1 wherein said door stopping plate is slideably insertable into said door stopping plate support arm.

13. The home invasion deterrent system of claim 11 wherein said door stopping plate support arm comprises all-thread.

14. The home invasion deterrent system of claim 12 wherein said door stopping plate support arm comprises a plurality of orifices and said door stopping plate comprises a plurality of through holes.

15. The home invasion deterrent system of claim 14 wherein one of said plurality of orifices may be aligned with one of said through holes and a rod entered through said said orifice and said through hole creating a user-preferred distance between said door stopping plate and an entry door.

16. The home invasion deterrent system of claim 10 wherein said cross-beam comprises at least two locking pins and said cross-beam is mounted between said vertical column assembly and an entry door.

17. A home invasion deterrent system comprising:
a floor bracket;
wherein said floor bracket comprises an aperture, said floor bracket is rigidly affixed to a floor in a flush-mounted condition;
wherein said floor bracket is floor mountable and receives said vertical column assembly;
a vertical column assembly having an upper end and a lower end;
wherein said vertical column comprises a door stopping plate support arm affixed at a right angle to said upper end of said vertical column assembly;
wherein said vertical column assembly is rigidly inserted into a core hole in a concrete floor or swingably attached to an adjacent surface;
a door stopping plate;
a door stopping plate support arm;
wherein said door stopping plate is slideably insertable into said door stopping plate support arm;
wherein said door stopping plate support arm comprises a plurality of orifices;
wherein said door stopping plate comprises a plurality of through holes;
wherein said door stopping plate comprises a rubber bumper;
wherein one of said plurality of orifices may be aligned with one of said through holes and a rod entered through said orifice and said through hole creating a user-preferred distance between said door stopping plate and an entry door;
wherein said vertical column assembly enables an occupant to open an entry door a predetermined rotatable distance to ascertain a visitor's identity;
wherein said door stopping plate support arm and door stopping plate act as a door stop; and
wherein said vertical column assembly when locked creates a door swing limiter whereby a potential home invader is prevented from ingressing an entryway.

18. The home invasion deterrent system of claim 17 further comprising a kit having:
at least one said floor bracket;
at least one said vertical column assembly;
at least one said door stopping plate support arm;
at least one said door stopping plate with rubber bumper;
at least one said locking pin; and
a set of user instructions.

19. A method of use for a home invasion deterrent system comprising the steps of:
inserting a vertical column assembly having an upper end and a lower end into a floor bracket and core hole;
adjusting a door stopping plate support arm with a rubber bumper to a desired position; and
inserting a locking pin through said door stopping plate support arm to secure a door.

20. The method of use of a home invasion deterrent system of claim 19 further comprising the steps of:
removing said door stopping plate support arm with said rubber bumper; and
opening said door providing an egress and ingress pathway for a user.
